(19) United States
(12) Patent Application Publication
(10) Pub. No.: US 2008/0258524 A1
(43) Pub. Date: Oct. 23, 2008

(54) JUVENILE VEHICLE SEAT WITH BACKWARD-FOLDING BACKREST

(75) Inventors: Paul T. Zink, Indianapolis, IN (US); Dennis M. Turner, Mooresville, IN (US); Andrew B. Mendenhall, Mooresville, IN (US)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 12/104,317

(22) Filed: Apr. 16, 2008

Related U.S. Application Data
(60) Provisional application No. 60/913,182, filed on Apr. 20, 2007.

(51) Int. Cl. B60N 2/26

(52) U.S. Cl. 297/250.1

(57) ABSTRACT

A juvenile vehicle seat includes a seat base adapted to set on a vehicle seat and a foldable backrest associated with the seat base. The juvenile vehicle seat also includes a releasable backrest lock.

This application claims priority under 35 U.S.C. §119(e) to U.S. Provisional Application Ser. No. 60/913,182, filed Apr. 20, 2007, which is expressly incorporated by reference herein.

### BACKGROUND

The present disclosure relates to juvenile vehicle seats, and in particular, to vehicle seats having backrests that move relative to seat bottoms. More particularly, the present disclosure relates to a foldable juvenile vehicle seat having a releasable backrest lock.

### SUMMARY

A juvenile vehicle seat in accordance with the present disclosure includes a stationary seat base and a seat back. The seat back includes a foldable backrest.

In illustrative embodiments, a backrest retainer is configured normally to lock the foldable backrest in an upright use position relative to the stationary seat base. The foldable backrest is able to fold in a backward direction away from a seating surface provided on the seat base whenever the backrest retainer is disabled to release the foldable backrest.

In illustrative embodiments, the backrest retainer can be operated by a caregiver so that the foldable backrest is released and free to move relative to the seat base to assume a compact folded storage position. The backrest is arranged to fold in a backward direction away from a seating surface provided on the seat base when it is moved from the upright use position to the compact folded storage position. In the compact folded storage position, the foldable backrest is arranged to lie under and extend along a downwardly facing bottom surface of the seat base.

In illustrative embodiments, the backrest retainer includes two backrest locks. A first backrest lock is located on one (left) side of the seat base and a second backrest lock is located on an opposite (right) side of the seat base.

In some illustrative embodiments, each backrest lock includes an anchor associated with the foldable backrest and an anchor receiver associated with the seat base. The anchor is mounted for movement with the foldable backrest relative to the seat base between a backrest-locking position engaging the companion anchor receiver included in the seat base and a backrest-releasing position disengaging that anchor receiver. The anchor is coupled to the foldable backrest and is configured normally to anchor the foldable backrest to the seat base upon movement of the anchor to the backrest-locking position engaging the anchor receiver included in the seat base so that the foldable backrest is retained in the upright use position.

A caregiver can operate the first and second backrest locks to release the foldable backrest to allow movement of the foldable backrest to the backrest-releasing position disengaging the first and second anchors from the first and second anchor receivers formed in the seat base. Once the foldable backrest is released, the caregiver can pivot the backrest backwardly about a pivot axis relative to the seat base to move the foldable backrest toward the compact folded storage position.

In other illustrative embodiments, each backrest lock includes a spring-loaded pushbutton supported for movement in a channel formed in the seat base and coupled to a motion blocker mounted for movement in a passageway formed in the seat back. A return spring is arranged normally to urge the pushbutton and the motion blocker to a backrest-locking position engaging the foldable backrest to lock the foldable backrest in either the upright use position or the compact folded storage position. A user can apply an inwardly directed force to the pushbutton to compress the return spring so as to move the motion blocker to a backrest-releasing position disengaging the foldable backrest so that the foldable backrest is free to move between the upright use and compact folded storage positions.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a juvenile vehicle seat in accordance with the present disclosure showing a backrest retainer that has been enabled to retain a foldable backrest in an upright use position relative to a seat base;

FIG. 2 is a view similar to FIG. 1 showing that the foldable backrest has pivoted in a backward direction away from a seating surface provided on the seat base to assume a rearwardly extending layout position after the backrest retainer has been disabled;

FIG. 3 is a perspective view of an illustrative juvenile vehicle seat in accordance with the present disclosure showing a seat back including a foldable backrest retained in an upright use position relative to a stationary seat base by a backrest retainer comprising a first backrest lock including a vertical block-shaped first anchor on one side of the foldable backrest and a second backrest lock including a vertical block-shaped second anchor on another side of the foldable backrest;

FIG. 4 is a view similar to FIG. 3 showing upward movement of the foldable backrest away from the seat base to disengage block-shaped first and second anchors included in the seat back and coupled to the foldable backrest from companion anchor receivers formed in the seat base to free the foldable backrest so that it can be pivoted backwardly in a clockwise direction about a pivot axis established by an axle included in the seat back and coupled to the foldable backrest;

FIG. 5 is a view similar to FIGS. 3 and 4 after completion of backward-folding movement of the foldable backrest and arrival of the foldable backrest at a compact folded storage position located underneath the stationary seat base;

FIG. 6 is a side elevation view of the juvenile vehicle seat of FIG. 3 showing insertion of the first anchor into a companion first anchor receiver formed in the seat base to retain the foldable backrest in the upright use position relative to the stationary seat base and showing cooperation of the first anchor and companion first anchor receiver to define a first of two backrest locks included in a backrest retainer provided in the juvenile vehicle seat;

FIG. 7 is a side elevation view similar to FIG. 6 showing upward movement of the unlocked foldable backrest in response to a lifting force applied to the foldable backrest by a caregiver to (1) withdraw the first anchor from the companion first anchor receiver formed in the seat base to unlock the first backrest lock and release the foldable backrest so that it is free to move to the compact folded storage position as suggested in FIG. 8 and (2) raise the axle upwardly from a lowest position in an axle-receiving slot formed in the seat base as shown in phantom in FIG. 6 to a highest position in the axle-receiving slot as shown in FIG. 7;

FIG. 8 is a side elevation view similar to FIGS. 6 and 7 showing movement of the foldable backrest to assume a compact folded storage position under the stationary seat base after (1) first-stage pivoting motion of the seat back about the axle through about a 90° angle in a clockwise direction to assume a rearwardly extending layout position while the axle remains in the highest position in the axle-receiving slot as suggested in phantom in FIG. 7, (2) downward motion of the foldable backrest (while remaining in the layout position) as the axle moves downwardly from the highest position to the lowest position in the axle-receiving slot, and (3) second-stage pivoting motion of the foldable backrest about the axle through about a 180° angle in a clockwise direction to assume the compact folded storage position underneath the seat base while the axle remains in the lowest position in the axle-receiving slot;

FIG. 9 is a perspective view of an illustrative juvenile vehicle seat in accordance with another embodiment of the present disclosure showing a seat back including a foldable backrest retained in an upright use position relative to a stationary seat base;

FIG. 10 is a view similar to FIG. 9 showing illustrative operation (by a user) of first and second backrest locks included in a backrest retainer included in the seat back to unlock the backrest locks and free the seat back so that it can be pivoted backwardly in a clockwise direction about a pivot axis relative to the stationary seat base;

FIG. 11 is a view similar to FIGS. 9 and 10 after completion of backward-folding movement of the foldable backrest and arrival of the foldable backrest at a compact folded storage position located underneath the stationary seat base;

FIG. 12 is an enlarged exploded perspective view of a portion of the juvenile vehicle seat of FIGS. 9-11 showing components included in an illustrative first backrest lock;

FIG. 13 is an enlarged sectional view taken along line 13-13 of FIG. 9 showing the first backrest lock in a locked position;

FIG. 14 is an enlarged sectional view taken along line 14-14 of FIG. 10 showing the first backrest lock in an unlocked position;

FIG. 15 is a sectional view taken along line 15-15 of FIG. 13; and

FIG. 16 is a sectional view taken along line 16-16 of FIG. 14.

### DETAILED DESCRIPTION

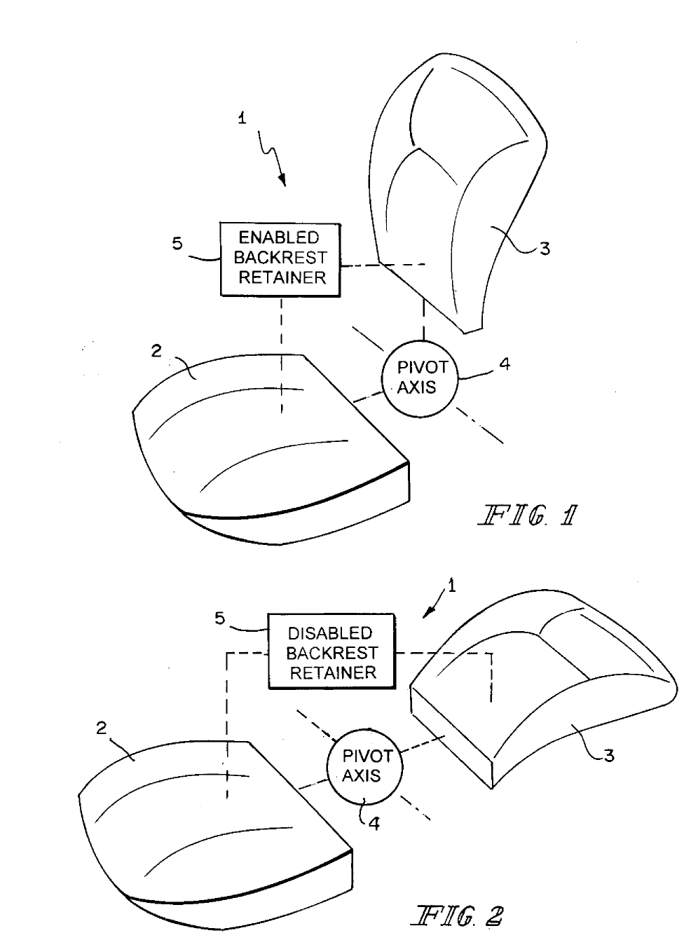

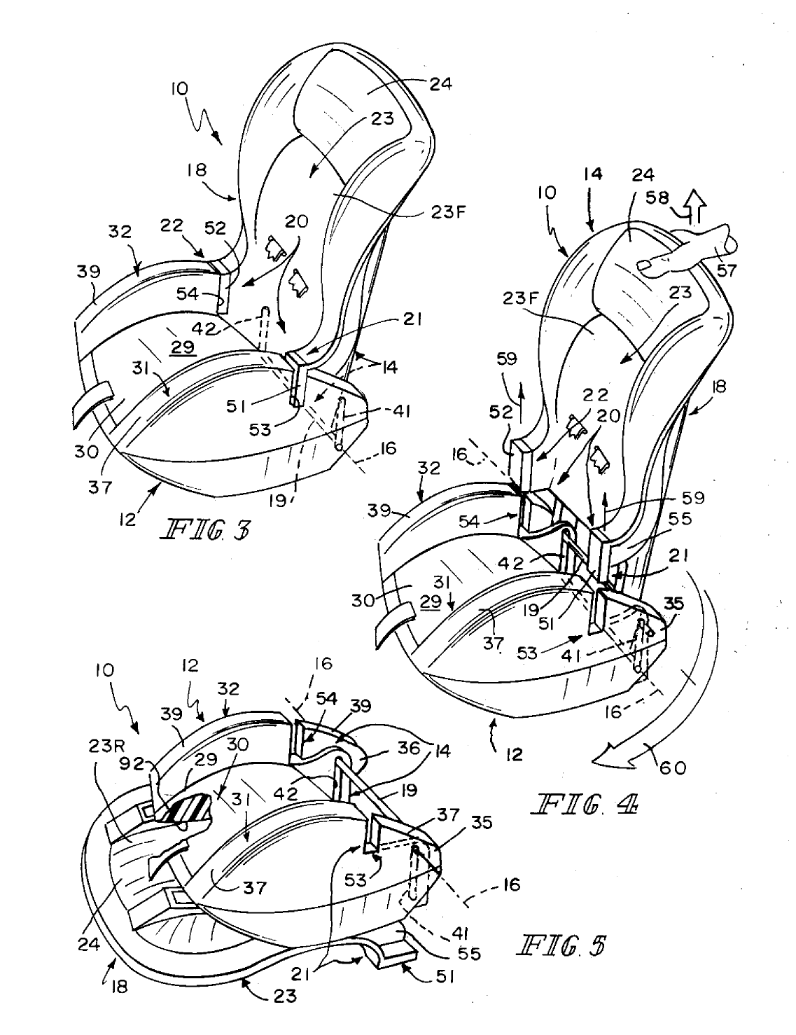

A juvenile vehicle seat 1 in accordance with the present disclosure includes a seat base 2, a foldable backrest 3 mounted for movement relative to seat base 2 about a pivot axis 4, and a backrest retainer 5 as suggested in FIG. 1. When backrest retainer 5 is disabled, foldable backrest 3 can be moved to assume a rearwardly extending layout position suggested in FIG. 2. Foldable backrest 3 can be moved about pivot axis 4 to assume an upright use position suggested in FIG. 1 and backrest retainer 5 can function to provide means for retaining foldable backrest 3 in the upright use position. Other illustrative embodiments of juvenile vehicle seats in accordance with the present disclosure are illustrated in FIGS. 3-8 and FIGS. 9-16.

A juvenile vehicle seat 10 includes a seat base 12 and a seat back 14 coupled to seat base 12 at a pivot axis 16 as suggested in FIGS. 3-5. Seat back 14 includes a foldable backrest 18 and an axle 19 coupled to foldable backrest 18 and to scat base 12 to establish pivot axis 16 as suggested in FIGS. 3 and 6-8.

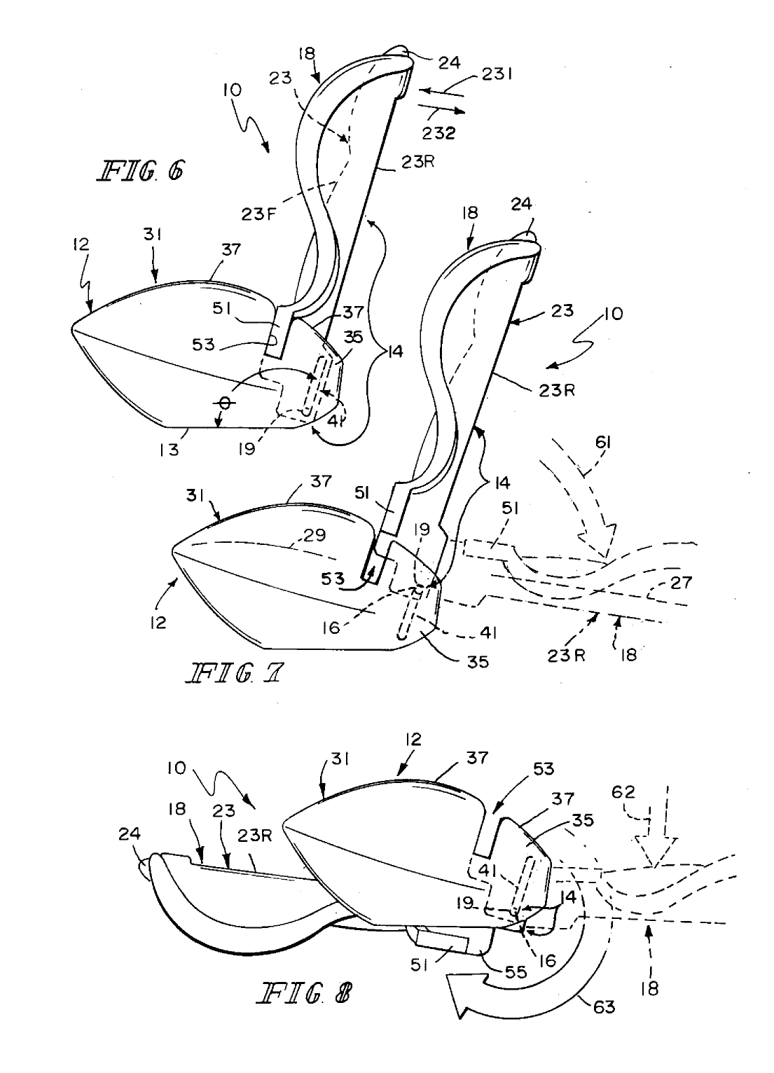

A backrest retainer 20 is included in juvenile vehicle seat 10 and configured normally to retain foldable backrest 18 in an upright use position shown in FIGS. 3 and 6. Backrest retainer 20 can be operated manually by a caregiver 57 as suggested illustratively in FIGS. 4 and 7 to free foldable backrest 18 so that, once freed, foldable backrest 18 can be pivoted backwardly about pivot axis 16 established by axle 19 as suggested in FIG. 7 to assume a rearwardly extending layout position shown (in phantom) in FIG. 7 and a compact folded storage position shown (in solid), for example, in FIGS. 5 and 8.

As suggested in FIG. 3, backrest retainer 20 includes a first backrest lock 21 on one side of foldable backrest 18 and a second backrest lock 22 on another side of foldable backrest 18. Foldable backrest 18 includes a back support 23 and a head support 24 coupled to an upper portion of back support 23. Back support 23 includes a juvenile-engaging surface 23F facing in a first direction 231 and a rear surface 23R facing in an opposite second direction 232 as suggested in FIG. 6.

Seat base 12 includes first and second armrests 31, 32 and a seat bottom 30 arranged to lie between and below first and second armrests 31, 32, as suggested in FIG. 3. Seat bottom 30 includes an upwardly facing seating surface 29 and a downwardly facing underside 92 as suggested in FIG. 5.

Foldable backrest 18 is arranged to extend upwardly from and lie above seat bottom 30 and in a space provided between first and second armrests 31, 32 when foldable backrest 18 is moved to assume the upright use position as suggested in FIGS. 3 and 6. It is within the scope of the present disclosure to use armrests 31, 32 as left and right thigh-support rims and provide other fixed or movable armrests on seat base 12 or seat back 14.

An axle 19 is included in seat back 14 of juvenile vehicle seat 10 as shown, for example, in FIG. 5. Axle 19 is arranged and configured to establish pivot axis 16. Axle 19 is coupled to a lower portion of foldable backrest 18 to move therewith relative to seat base 12 as suggested in FIGS. 6-8. It is within the scope of this disclosure to couple axle 19 to any suitable portion of foldable backrest 18 and to use an axle comprising only one long segment or two or more separate shorter segments.

Axle 19 is arranged to slide up and down in first and second axle-receiving slots 41 and 42 formed in seat base 12 as shown in FIGS. 3-5 in a manner suggested in FIGS. 6-8. Such up-and-down motion occurs during folding movement of foldable backrest 18 relative to seat base 12. In illustrative embodiments, axle-receiving slots 41, 42 are formed in rear portions 35, 36 of first and second armrests 31, 32, respectively. In an illustrative embodiment, each of axle-receiving slots 41, 42 is oriented to cooperate with a straight bottom edge 13 of seat base 12 to define an included angle θ of about 107° therebetween as shown, for example, in FIG. 6.

As suggested in FIGS. 3-5, first backrest lock 21 comprises a first anchor 51 coupled to foldable backrest 18 and a companion first anchor receiver 53. First anchor receiver 53 is formed in first armrest 31 and sized to receive first anchor 51 therein as shown in FIGS. 3 and 6 to retain foldable backrest 18 in the upright use position. In an illustrative embodiment, first anchor 51 is block-shaped and coupled to a lower side portion 55 of foldable backrest 18 as shown, for example, in FIG. 5. First anchor receiver 53 is a slot formed in first armrest 31 as shown best in FIG. 5 to have an anchor-receiving top opening in a top edge 37 of first armrest 31.

As also suggested in FIGS. 3-5, second backrest lock 21 comprises a second anchor 52 coupled to foldable backrest 18 and a companion second anchor receiver 54. Second anchor receiver 54 is formed in second armrest 32 and sized to receive second anchor 52 therein as shown, for example, in FIG. 3 to retain foldable backrest IS in the upright use position. In an illustrative embodiment, second anchor 52 is block-shaped and coupled to a lower side portion of foldable backrest 18 as suggested in FIG. 4. Second anchor receiver 54 is a slot formed in second armrest 32 as shown best in FIG. 5 to have an anchor-receiving top opening in a top edge 39 of second armrest 32.

First and second anchor receivers 53, 54 are arranged to lie in spaced-apart location to one another as suggested in FIG. 4 and 5 to locate a portion of seating surface 29 of seat bottom 30 therebetween. Also, juvenile-engaging surface 23F of back support 23 of foldable backrest 18 is positioned to lie in a space provided between first and second anchors 51, 52 and rear surface 23R of back support 23 as suggested in FIGS. 3 and 6.

Movement of foldable backrest 18 from the upright use position shown in FIGS. 3 and 6 to the rearwardly extending layout position shown in phantom in FIG. 7 and then to the compact folded storage position shown in solid in FIGS. 5 and 8 is initiated by unlocking first and second backrest locks 21, 22 manually as suggested in FIGS. 4 and 7. Then foldable backrest 18 is folded to move in backward direction 60 as suggested in FIG. 4 away from seat bottom 30 of seat base 12 and to assume the compact folded storage position under seat base 12 as suggested in FIGS. 5 and 8.

In illustrative embodiments, a caregiver 57 first applies a lifting force 58 to foldable backrest 18 to raise foldable backrest 18 relative to seat base 12 so as to withdraw first anchor 51 from companion first anchor receiver 53 to unlock first backrest lock 21 and to withdraw second anchor 52 from companion second anchor receiver 54 to unlock second backrest lock 22. In response to lifting force 58, each of first and second anchors 51, 52 moves upwardly in direction 59 away from seat base 12 as suggested in FIG. 4. As a result of such upward movement of foldable backrest 18, the axle 19 coupled to foldable backrest 18 is raised upwardly in direction 59 from a lowest position in each of axle-receiving slots 41, 42 (shown in phantom in FIG. 3) formed in seat base 12 to a highest position in each of axle-receiving slots 41, 42 (shown in phantom in FIG. 4).

Foldable backrest 18 can be moved now in, for example, three stages relative to seat base 12 to arrive in the compact folded storage position as suggested in FIGS. 7 and 8. In a first stage, as suggested in FIG. 7, raised foldable backrest 18 is pivoted about axle 19 through about a 90° angle in clockwise direction 61 to assume a rearwardly extending layout position (shown in phantom) while axle 19 remains in the highest position in each of axle-receiving slots 41, 42. In this rearwardly extending layout position, a juvenile-engaging surface 23F on back support 23 of foldable backrest 18 is aligned to lie in side-by-side relation to a seating surface 29 on seat bottom 30 as suggested, for example, in FIG. 7. In a second stage, as suggested in FIG. 8, foldable backrest 18 is moved downwardly in direction 62 while remaining in the rearwardly extending layout position to cause axle 19 to move downwardly in direction 62 from the highest position (see FIG. 7) to the lowest position (see FIG. 8) in axle-receiving slots 41, 42 formed in seat base 12. In a third stage, as also suggested in FIG. 8, foldable backrest 18 is pivoted about axle 19 through about an 180° angle in clockwise direction 63 to assume the compact folded storage position underneath seat base 12 while axle 19 remains substantially in the lowest position in axle-receiving slots 41, 42. In this compact folded storage position, rear surface 23R on back support 23 of foldable backrest 18 is arranged to lie in confronting relation to underside 92 of seat bottom 30 of seat base 12 as shown, for example, in FIG. 5. Foldable backrest 18 can be restored to its upright use position by reversing this folding process.

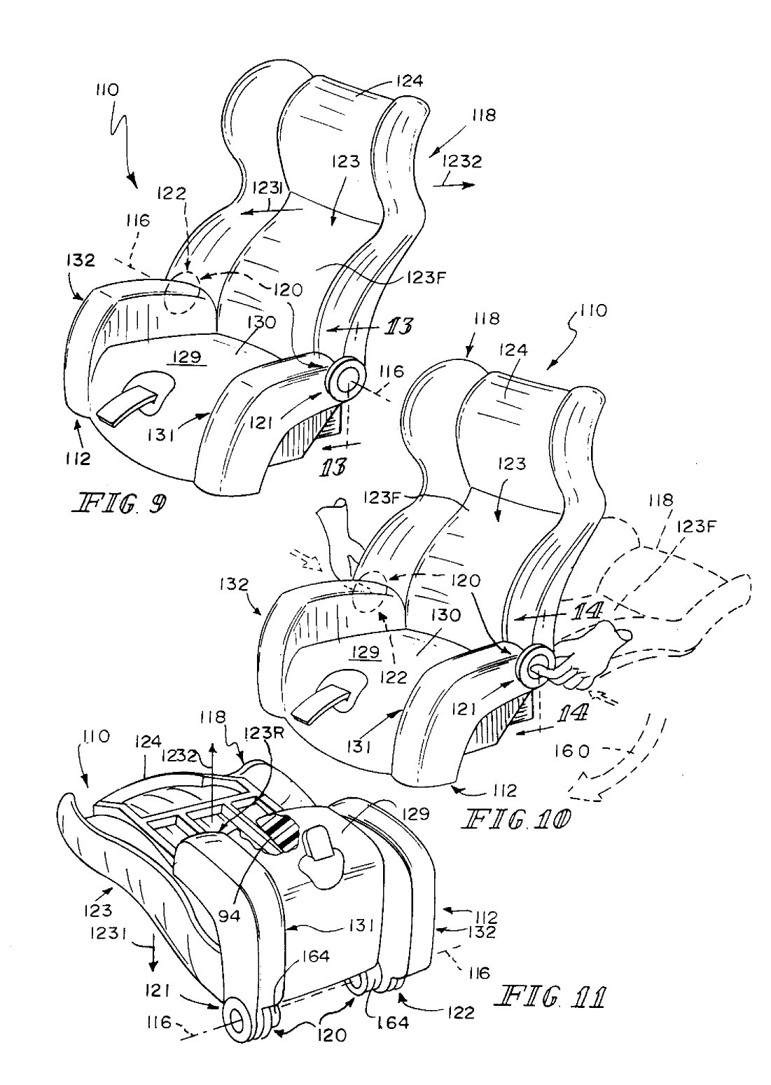

A juvenile vehicle seat 110 in accordance with yet another embodiment of the present disclosure is shown, for example, in FIGS. 9-16. Juvenile vehicle seat 110 includes a seat base 112 and a seat back 114 coupled to seat base 112 at a pivot axis 116 as suggested in FIGS. 9-11. Seat back 114 includes a foldable backrest 118 and a backrest retainer 120 including an axle 119 comprising two separate pivot rods 125 coupled to foldable backrest 118 and to seat base 112 to establish pivot axis 116 as suggested in FIG. 11.

Backrest retainer 120 is configured normally to retain foldable backrest 118 in an upright use position shown in FIG. 9. Backrest retainer 120 can be operated manually by a caregiver 57 as suggested illustratively in FIG. 10 to free foldable backrest 118 so that, once freed, foldable backrest 118 can be pivoted backwardly about pivot axis 116 in clockwise direction 160 through an angle of about 270° to assume first a rearwardly extending layout position shown, for example in phantom in FIG. 10 and then a compact folded storage position shown, for example, in FIG. 11.

As suggested in FIG. 9, backrest retainer 120 includes a first backrest lock 121 on one side of foldable backrest 118 and a second backrest lock 122 on another side of foldable backrest 118. Foldable backrest 118 includes a back support 123 and a head support 124 coupled to an upper portion of backrest 118 as shown in FIG. 3. Back support 123 includes a juvenile-engaging surface 123F facing in a first direction 1231 and a rear surface 123R facing in an opposite second direction 1232 as suggested in FIGS. 9 and 11.

Seat base 112 includes first and second armrest 131, 132 and a seat bottom 130 arranged to lie between and below first and second armrests 131, 132 as suggested in FIG. 9. Seat bottom 130 includes an upwardly facing seating surface 129 and a downwardly facing underside 921 as suggested in FIG. 11.

Foldable backrest 118 is arranged to extend upwardly from and lie above seat bottom 130 and in a space provided between first and second armrests 131, 132 when foldable backrest 118 is moved to assume the upright use position as suggested in FIG. 3. It is within the scope of the present disclosure to use armrests 131, 132 as left and right thigh-support rims and provide other fixed or movable armrests on seat base 112 or seat back 114.

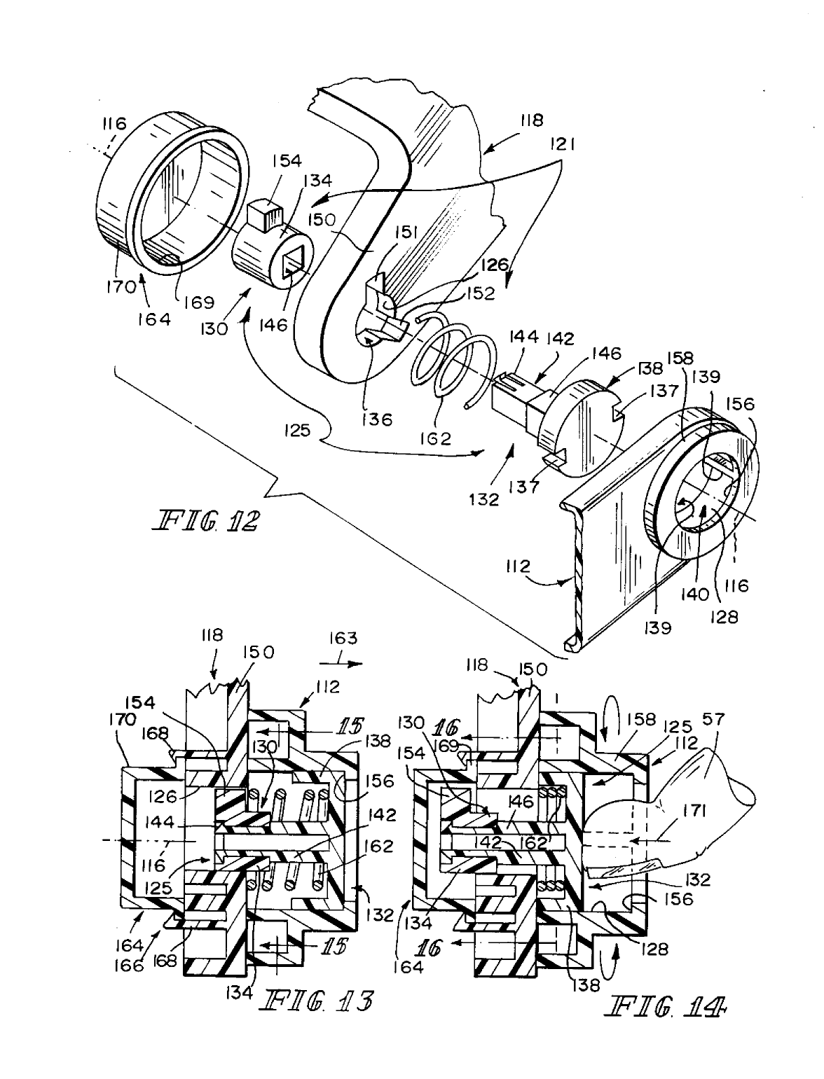

In an illustrative embodiment, first and second backrest locks 121, 122 cooperate to provide axle means 119 for supporting foldable backrest 118 for pivotable movement relative to seat base 112 about pivot axis 116 as suggested in FIGS. 11 and 13-16. Each of backrest locks 121, 122 includes a pivot rod 125 mounted to lie in rotative bearing engagement with a companion cylinder-shaped bearing surface 126 included in seat back 114 and a companion cylinder-shaped bearing surface 128 included in seat base 112 as suggested in FIGS. 12-14.

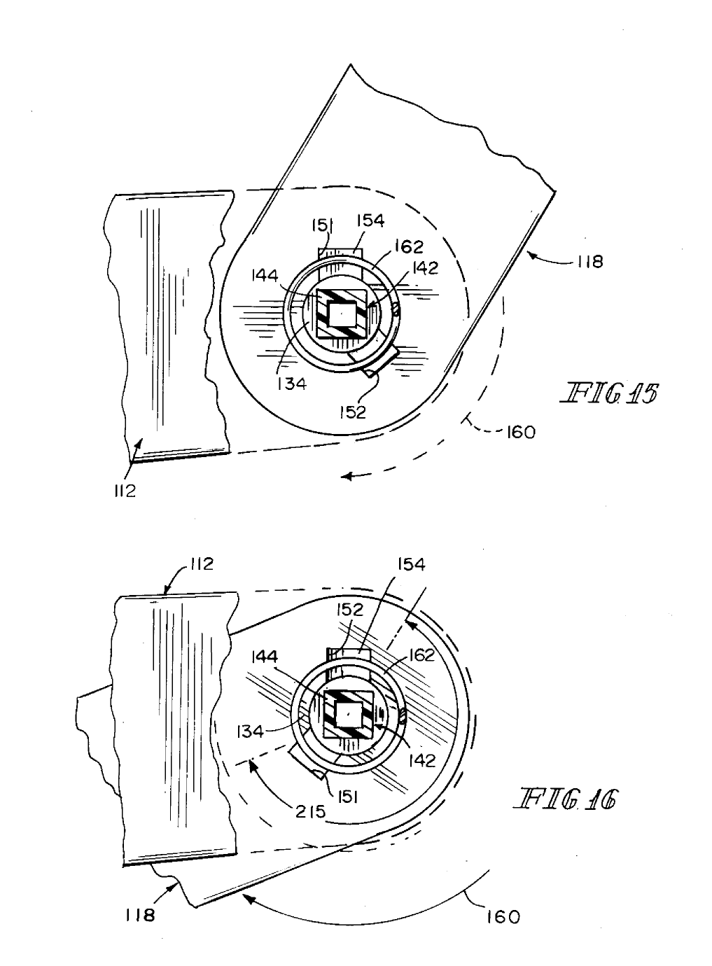

Pivot rod 125 comprises a motion blocker 130 and a blocker mover 132 coupled to motion blocker 130 a shown, for example, in FIGS. 13 and 14. In an illustrative embodiment, motion blocker 130 includes a cylinder-shaped barrel 134 sized to slide back and forth in a passageway 136 defined by cylinder-shaped bearing surface 126 along a line that is coextensive with pivot axis 116. Also, blocker mover 132 includes a cylinder-shaped pushbutton 138 sized to slide in a passageway 140 defined by cylinder-shaped bearing surface 128 also along pivot axis 116 as suggested in FIGS. 13 and 14. Pushbutton 138 is formed to include at least one lug-receiving slot 137 formed to receive an anti-rotation lug 139 provided in passageway 140 to block rotation of pushbutton 138 (and all of pivot rod 125) about pivot axis 116 during back-and-forth sliding movement of pivot rod 125 in passageways 136, 140.

As suggested in FIG. 12, blocker mover 132 of pivot rod 125 also includes an elongated barrel mount 142 coupled at one end to pushbutton 138. A free end 144 of barrel mount 142 extends into a mount receiver 146 formed in barrel 134 as suggested in FIG. 12 and shown in FIGS. 13 and 14. Free end 144 is formed to include means for mating with barrel 134 to retain barrel 134 and barrel mount 142 in fixed relation to one another. A proximal portion 146 of barrel mount 142 interconnects pushbutton 138 and free end 144 as suggested in FIGS. 12 and 13. In the illustrated embodiment, mount receiver 146 is a channel having a square-shaped opening sized to receive free end 144 configured to have a matching square-shaped cross-section.

Foldable backrest 118 is formed to include a pivot flange 150 associated with each pivot rod 125 as suggested in FIG. 12. Pivot flange 150 is formed to include passageway 136, a first lug receiver 151 opening into passageway 136, and a second lug receiver 152 opening into passageway 136 as shown, for example, in FIG. 12. First and second lug receivers 151, 152 are located to cooperate to form an included angle 215 of about 215° therebetween as suggested, for example, in FIGS. 15 and 16.

Motion blocker 130 of pivot rod 125 further includes a locking lug 154 coupled to barrel 134 to slide back and forth therewith along pivot axis 116 as suggested in FIGS. 12 and 14. Locking lug 154 is arranged to extend radially outwardly away from passageway 146 formed in barrel 134 as suggested in FIG. 12.

Locking lug 154 is sized to fit into each of first lug receiver 151 and second lug receiver 152 as suggested in FIGS. 15 and 16. Locking lug 154 is arranged and oriented to extend into first lug receiver 151 as shown in FIG. 15 to block pivotable movement of foldable backrest 118 relative to seat base 112 about pivot axis 116 to retain foldable backrest 118 in the upright use position. Locking lug 154 is also arranged and oriented to extend into second lug receiver 152 as shown in FIG. 16 to block pivotable movement of foldable backrest 118 relative to seat base 112 about pivot axis 116 to retain foldable backrest 118 in the compact folded storage position. When locking lug 154 is withdrawn from both of first and second lug receivers 151, 152, then foldable backrest 118 is free to pivot about pivot axis 116 relative to seat base 112.

Seat base 112 is formed to include a radially inwardly extending button stop flange 156 coupled to an outer end of an annular side wall 158 defining a portion of cylinder-shaped bearing surface 128. A return spring 162 is included in each backrest lock 121, 122 and arranged normally to urge blocker mover 132 in axially outer direction 163 as suggested in FIG. 13 to cause pushbutton 138 to bear against radially inwardly extending button stop flange 156 and to cause locking lug 154 to extend into and remain in either first or second lug receiver 151, 152, depending upon whether foldable backrest 18 lies in an upright use position as suggested in FIG. 13 or a compact folded storage position as suggested in FIG. 16.

Each of backrest locks 121, 122 also includes an inner cap 164 as suggested in FIGS. 11 and 12. Each inner cap 164 is mated to a companion cap retainer 166 coupled to pivot flange 150 of seat back 112. In illustrative embodiments, cap retainer 166 includes several retention fingers 168 arranged to extend inwardly in parallel relation to pivot axis 116 and configured to grip a retaining ring 169 included in inner cap 164 and coupled to a shell 170 also included in inner cap 164 as suggested in FIGS. 13 and 14.

In operation, a caregiver can apply an external force in direction 171 to pushbutton 138 of blocker mover 132 as suggested in FIG. 14 to cause motion blocker 130 also to move inwardly in direction 171. Such inward motion compresses return spring 162 and disengages locking lug 154 from either first or second lug receiver 151, 152. The caregiver is now free to pivot foldable backrest 118 backwardly relative to seat base 112 about pivot axis 116 to cause foldable backrest 118 to move either to the upright use position shown in FIG. 9, the rearwardly extending layout position shown in phantom in FIG. 10, or the compact folded storage position shown in FIG. 11. The compressed return spring 162 will expand as soon as foldable backrest 118 arrives at either one of its new use or storage positions to urge locking lug 154 into the lug receiver (151 or 152) associated with the new position to, once again, retain foldable backrest 118 in a fixed position relative to seat base 112. As suggested in FIG. 10, in the rearwardly extending layout position, a juvenile-engaging surface 127 back support 123 of foldable backrest 118 is aligned to lie in side-by-side relation to a seating surface 129 on seat bottom 130.

1. A juvenile vehicle seat comprising
a seat base adapted to set on a vehicle seat and configured to include a seat bottom, the seat bottom including an upwardly facing seating surface adapted to support a juvenile in a seated position on the seat bottom and a downwardly facing underside, and
a seat back including an axle coupled to the seat base and a foldable backrest mounted on the axle for folding movement in a backward direction away from the upwardly facing seating surface on the seat bottom about a pivot axis established by the axle through an angle that is greater than 180° from an upright use position arranged to extend upwardly from the upwardly facing seating surface and adapted to support a juvenile in a seated position on the seat bottom and a compact folded storage position arranged to lie under and extend along the downwardly facing underside of the seat bottom.

2. The juvenile seat of claim 1, wherein the foldable backrest includes a juvenile-engaging surface arranged to face in a first direction and adapted to engage a back of a juvenile seated on the seat bottom when the foldable backrest is moved to assume the upright use position, the foldable backrest further includes a rear surface arranged to face in an opposite second direction, and the rear surface is arranged to lie in confronting relation to the downwardly facing underside of the seat bottom and between the back-engaging front surface of the foldable backrest and the downwardly facing underside of the seat bottom upon movement of the folding backrest to assume the compact folded storage position.

3. The juvenile seat of claim 2, further comprising a backrest retainer configured to provide means for temporarily retaining the foldable backrest in the upright use position and for releasing the foldable backrest so that the foldable backrest can fold backwardly during movement from the upright use position to the compact folded storage position.

4. The juvenile vehicle seat of claim 1, wherein the seat base is formed to include an axle-receiving slot and the axle is arranged to extend into the axle-receiving slot and move up and down therein during folding movement of the foldable backrest relative to the seat base between the upright use position and the compact folded storage position.

5. The Juvenile vehicle seat of claim 4, further comprising a first backrest lock including a first anchor coupled to the foldable backrest to move therewith and a companion first anchor receiver formed in the seat base and sized to receive the first anchor therein upon movement of the foldable backrest to the upright use position to retain the foldable backrest in the upright use position.

6. The juvenile vehicle seat of claim 4, wherein the axle is arranged to lie in a lowest position in the axle-receiving slot and to move upwardly in the axle-receiving slot in response to withdrawal of the first anchor from the first anchor receiver.

7. The juvenile vehicle seat of claim 1, wherein the seat back further includes a backrest retainer configured to retain the foldable backrest in the upright use position, the backrest retainer includes first and second backrest locks, and each of the first and second backrest locks includes a portion of the axle.

8. The juvenile vehicle seat of claim 7, wherein the first backrest lock includes a pivot rod configured to define the portion of the axle and mounted to lie in rotative bearing engagement with a companion bearing surface included in the seat back and a companion bearing surface included in the seat base.

9. The juvenile seat of claim 8, wherein the pivot rod includes a motion blocker and a blocker mover coupled to the motion blocker, the motion blocker includes a barrel sized to slide back and forth in a passageway defined by the companion bearing surface included in the seat back along a line that is coextensive with the pivot axis and a locking lug coupled to the barrel to slide back and forth therewith, the locking lug is arranged and oriented to extend into a first lug receiver formed in the seat back to block pivotable movement of the foldable backrest relative to the seat base about the pivot axis to retain the foldable backrest in the upright use position, the locking lug is arranged and oriented to extend into a second lug receiver formed in the seat back to block pivotable movement of the foldable backrest relative to the seat base about the pivot axis to retain the foldable backrest in the compact folded storage position, and the foldable backrest is free to pivot about the pivot axis when the locking lug is withdrawn from both of the first and second lug receivers.

10. The juvenile seat of claim 9, wherein the blocker mover is configured to provide means for moving the barrel along the axis of rotation to withdraw the locking lug from one of the first and second lug receivers.

11. A juvenile vehicle seat comprising
a seat base adapted to set on a vehicle seat and configured to include a seat bottom adapted to support a juvenile in a seated position and an axle,
a foldable backrest mounted on the axle for folding movement in a backward direction away from a seating surface on the seat bottom about a pivot axis established by the axle, and
a backrest retainer configured to retain the foldable backrest in an upright use position arranged to extend upwardly away from the seat bottom and adapted to cause a back support included in the foldable backrest to support a juvenile in the seated position on the seat bottom and to release the foldable backrest to free the foldable backrest so that, once freed, the foldable backrest can be pivoted about the pivot axis in the backward direction to assume a rearwardly extending layout position to align a back-engaging surface provided on the back support of the foldable backrest in side-by-side relation to the seating surface provided on the seat bottom.

12. The juvenile vehicle seat of claim 11, wherein the backrest retainer includes a first backrest lock and a second backrest lock arranged to lie in spaced-apart relation to the first backrest lock, the first backrest lock includes a first anchor coupled to the foldable backrest to move therewith and a first anchor receiver formed in the seat base and sized to receive the first anchor therein to retain the foldable backrest in the upright use position, and the second backrest lock includes a second anchor coupled to the foldable backrest to move therewith and a second anchor receiver formed in the seat base and sized to receive the second anchor therein to help retain the foldable backrest in the upright use position.

13. The juvenile vehicle seat of claim 12, wherein the first and second anchor receivers are arranged to lie in spaced-apart relation to one another to locate a portion of the seating surface of the seat bottom therebetween.

14. The juvenile vehicle seat of claim 12, wherein the first and second anchors are positioned to lie in spaced-apart relation to the pivot axis, the back-engaging surface is arranged to face in a first direction, the foldable backrest includes a rear-facing surface arranged to face in a second direction opposite to the first direction, and the back-engaging surface is positioned to lie in a space located between the first and second anchors and the rear-facing surface.

15. The juvenile vehicle seat of claim 11, wherein the backrest retainer includes a first anchor coupled to the foldable backrest to move therewith and a first anchor receiver formed in the seat base and sized to receive the first anchor therein to retain the foldable backrest in the upright use position.
